(19) United States
(12) Patent Application Publication
(10) Pub. No.: US 2025/0124761 A1
(43) Pub. Date: Apr. 17, 2025

(54) SETTLING OUTSTANDING LINE OF CREDIT LIABILITY WITH GAMING ESTABLISHMENT CREDIT SYSTEM

(71) Applicant: IGT, Las Vegas, NV (US)

(72) Inventors: Kevin Higgins, Reno, NV (US); Dwayne R. Nelson, Las Vegas, NV (US)

(21) Appl. No.: 18/990,123

(22) Filed: Dec. 20, 2024

Related U.S. Application Data
(63) Continuation of application No. 17/125,333, filed on Dec. 17, 2020.

(51) Int. Cl. G07F 17/32; G06Q 20/10; G06Q 20/24; G06Q 50/12

(52) U.S. Cl. CPC G07F 17/3244; G06Q 20/102; G06Q 20/24; G06Q 50/12

(57) ABSTRACT

A system that operates to monitor for a line of credit settlement event and, responsive to an occurrence of such an event, utilize a payment instrument and a hotel payment system to pay off an amount of funds accessed from a gaming establishment credit system.

### PRIORITY CLAIM

This application is a continuation of, claims priority to and the benefit of U.S. patent application Ser. No. 17/125,333, filed on Dec. 17, 2020, the entire contents of which is incorporated by reference herein.

### BACKGROUND

In various embodiments, the systems and methods of the present disclosure operate to monitor for a line of credit settlement event and, responsive to an occurrence of such an event, utilize a payment instrument and a hotel payment system to pay off an amount of funds accessed from a gaming establishment credit system.

Electronic gaming machines and gaming tables may enable a player to play a game wherein the player may be required to place a wager.

### BRIEF SUMMARY

In certain embodiments, the present disclosure relates to a system including a processor, and a memory device that stores a plurality of instructions. When executed by the processor responsive to a line of credit settlement event occurring in association with a hotel activity, the instructions cause the processor to determine an amount of an outstanding gaming establishment line of credit liability of a user, and cause the amount of the outstanding gaming establishment line of credit liability of the user to be settled, via a user selected payment instrument, with a gaming establishment credit system.

In certain embodiments, the present disclosure relates to a system including a processor, and a memory device that stores a plurality of instructions. When executed by the processor responsive to an anticipated line of credit use event occurring in association with a hotel activity, the instructions cause the processor to communicate user data to a gaming establishment credit system, the user data being obtained during the hotel activity. When executed by the processor responsive to the gaming establishment credit system approving a gaming establishment line of credit associated with the user, the instructions cause the processor to communicate data which results in a display device displaying an amount of credit available to be activated by the user in association with the gaming establishment line of credit.

In certain embodiments, the present disclosure relates to a method of operating a system responsive to a line of credit settlement event occurring in association with a hotel activity. In these embodiments, the method includes determining, by a processor, an amount of an outstanding gaming establishment line of credit liability of a user, and causing, by the processor, the amount of the outstanding gaming establishment line of credit liability of the user to be settled, via a user selected payment instrument, with a gaming establishment credit system.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are flow charts of example processes for operating a system which opens a line of credit with a gaming establishment credit system in association with a gaming establishment patron checking into a hotel.

FIG. 2C is a flow chart of an example process for operating a system which activates a line of credit with a gaming establishment credit system in association with an electronic gaming machine.

FIG. 2D is a flow chart of an example process for operating a system which settles an activated line of credit with a gaming establishment credit system in association with a gaming establishment patron settling a hotel room folio.

FIG. 3 is an example graphical user interface displayed in connection with a mobile device application and pertaining to a hotel room folio including funds activated from a line of credit.

### DETAILED DESCRIPTION

In various embodiments, upon a gaming establishment patron checking into a hotel of a gaming establishment, a gaming establishment hotel system operates with a gaming establishment credit system to potentially issue the gaming establishment patron a gaming establishment line of credit for an amount of funds usable at various touchpoints associated with the gaming establishment. Moreover, in various embodiments, upon the gaming establishment patron checking out of the hotel of the gaming establishment, the gaming establishment hotel system operates with the gaming establishment credit system to pay back part or all of the amount of outstanding funds associated with the gaming establishment line of credit using a designated payment instrument.

In certain embodiments, upon an anticipated line of credit use event occurring in association with a user, such as a gaming establishment patron checking into a hotel of a gaming establishment, a gaming establishment credit system determines whether or not to offer a line of credit to the user. In these embodiments, as part of the user checking into a hotel of the gaming establishment (or otherwise accessing one or more hotel services), a gaming establishment hotel system operates with the gaming establishment credit system to, subject to the user's authorization, potentially issue a line of credit for the user to use within various channels of commerce of the gaming establishment. In certain such embodiments, the gaming establishment hotel system communicates certain hotel check-in information associated with the user to the gaming establishment credit system which determines, based on the hotel check-in information associated with the user and any additional information obtained from any additional sources and/or subject to approval of an operator of the gaming establishment credit system, whether to authorize a line of credit for the user during their stay at the hotel of the gaming establishment. In certain such embodiments, in addition to potentially opening a line of credit with a gaming establishment as part of a hotel check-in process, the gaming establishment hotel system communicates certain hotel check-in information associated with the user to a gaming establishment fund management system which determines whether to open one or more gaming establishment accounts for the user, such as a cashless wagering account, to transfer funds to and from during their stay at the hotel of the gaming establishment. Accordingly, by utilizing various information provided to a gaming establishment hotel system (as part of a hotel check-in process) in the opening of a line of credit for a user and/or the opening of a gaming establishment account for the user, the system of the present disclosure streamlines the process of the opening of lines of credit and/or the opening gaming establishment accounts. Such a configuration saves users time in not having to rekey in or reprovide the same information multiple times. Such a configuration also reduces potential errors in different data sets maintained by different systems (i.e., not requiring the duplication of providing the same information multiple times reduces the risks in inconsistencies in such information) thereby increasing operational efficiencies of the different systems employed.

In certain embodiments, upon a line of credit settlement event occurring in association with a user, such as a gaming establishment patron checking out of a hotel of a gaming establishment, a gaming establishment credit system operates with a gaming establishment hotel system to pay back part or all of the amount of outstanding funds associated with the gaming establishment line of credit using a designated payment instrument. In these embodiments, when a user attempts to check-out of a hotel of a gaming establishment (or otherwise settle the amount of outstanding funds on a line of credit in association with a gaming establishment hotel system), the gaming establishment hotel system operates with the gaming establishment credit system to determine if the user is associated with an outstanding amount of funds activated from an issued line of credit. If the gaming establishment credit system determines that the user is associated with an outstanding amount of funds activated from an issued line of credit, the gaming establishment credit system operates with the gaming establishment hotel system to enable the user to pay off part or all of the outstanding amount of funds activated from the issued line of credit as part of the payment of the user's hotel room folio. Accordingly, to mitigate the risk that a user with an outstanding line of credit liability will not satisfy such a liability, the system of the present disclosure incorporates the settlement of an outstanding line of credit liability with the settlement of an outstanding gaming establishment hotel liability to provide a more streamlined and efficient process relating to lines of credits.

It should be appreciated that settling an outstanding line of credit liability as part of settling an outstanding gaming establishment hotel liability enables the user to employ one or more payment instruments not otherwise available to settle (or otherwise cost prohibitive in settling) an outstanding line of credit liability in isolation. That is, since certain jurisdictions prohibit the use of certain methods of payment directly at points of gambling (e.g., credit cards and debit cards cannot be used directly at electronic gaming machines and at gaming tables), when a user visits a gaming establishment, they typically gamble with cash they took into the gaming establishment, or use cash they obtained via an automated teller machine (“ATM”) or a cash advance kiosk. In recognition of these relatively limited options to fund one or more gambling sessions, certain gaming establishment credit systems enable users access to cash via opening up a line of credit or a marker at the gaming establishment where the user can draw down on the line of credit to obtain funds to gamble through the issuance of cash, gaming table chips, and/or cashless ticket vouchers. As part of accessing funds from a line of credit, the user becomes obligated to pay back the accessed funds from the line of credit or the user may face various penalties (e.g., interest fees, civil actions, and/or criminal actions). However, paying back an outstanding line of credit may be difficult for the user as the same cash or funding constraints exist, making it difficult for a user to pay off the funds accessed from a line of credit with anything except a check or wire transfer (which may take time to complete and/or be inconvenient for the user to initiate).

Moreover, since a merchant, such as a gaming establishment, must use a merchant category code (“MCC”) to describe the category of charges that constitute a transaction, attempting to pay off the funds accessed from a line of credit with a credit card or debit card results in the merchant quantifying the transaction using the MCC of gambling. However, identifying the transaction as pertaining to gambling leads to the automatic rejection of the credit card charges or to a treatment of the credit card charges as a cash advance associated with relatively high transaction fees. Put differently, paying back an outstanding line of credit may be difficult for a user because, in certain instances, the MCC associated with gambling transactions prevents the user from paying off the funds accessed from a line of credit with a credit card or debit card.

Accordingly and in recognition of at least the MCC mechanisms which prevent a user from paying off the funds accessed from a line of credit with a credit card or debit card and further in recognition that a gaming establishment hotel must use an MCC to describe the category of charges that are going to constitute the majority of the hotel room folio (e.g., gaming establishment hotels typically use a Hotel MCC, or a Food & Beverage MCC for transactions associated with non-gaming verticals, but they must use a gambling MCC for charges where the majority of the expenses are related to gambling), the system of the present disclosure enables the user to pay off the funds accessed from a line of credit at a gaming establishment hotel check-out using any payment instrument, including, but not limited to, credit cards and debit cards. That is, since the majority of transactions across all gaming establishment patrons will be associated with MCC hotel charges (e.g., an MCC for lodging) and MCC food & beverage charges, the system of the present disclosure enables the comingling of payments to settle a gaming establishment line of credit liability by utilizing the same MCC hotel charges and MCC food and beverage charges. Such a configuration enables a gaming establishment patron's line of credit to be reconciled at hotel checkout and charged to their hotel room folio to enable the gaming establishment patron to settle any amounts owed on an activated line of credit using any payment instrument, such as a credit card or debit card, wherein regardless of the payment instrument employed, a non-gambling MCC is employed for the charge. In other words, similar to how a hotel extends a hotel guest a line of credit for their stay at the hotel where this line of credit enables the hotel guest to charge certain activities (e.g., room service, food & beverage, valet fees) to their room that will ultimately be paid when the hotel guest checks out of the hotel, the system of the present disclosure expands the scope of this hotel guest line of credit to also include a gaming establishment line of credit that can be leveraged at any touchpoint within the gaming establishment during the hotel guest's stay.

### System Accounts

In various embodiments, the present disclosure is directed to a gaming establishment fund management system including various components or sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a player and/or retail patron, collectively form a resort or enterprise account (i.e., an integrated resort or gaming establishment fund management wallet) that the user may access to transfer funds and/or view balance information amongst the various accounts associated with or otherwise maintained for the user.

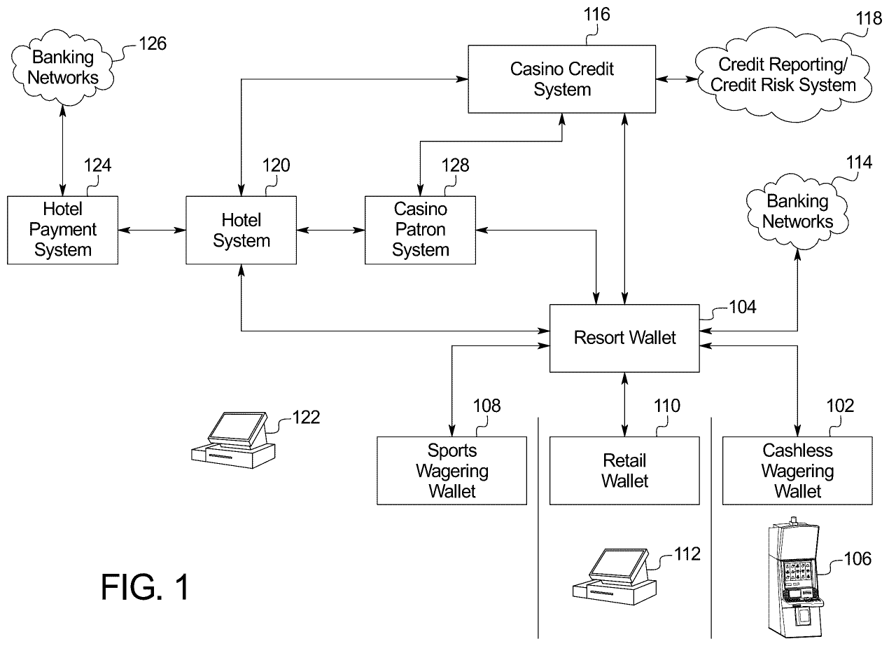

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user utilizes a mobile device application running on a mobile device and/or a physical instrument (e.g., a smart card or a user issued magnetic striped card which the user utilizes via inserting the card into a player tracking unit associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo machine and/or a sports betting terminal (that offers wagering games and/or sports betting opportunities)). For example, as seen in FIG. 1, the gaming establishment fund management system includes a first cashless wagering system (not shown) that maintains a cashless wagering wallet 102 (e.g., a first cashless wagering account) which is in communication with a resort wallet 104, wherein such components of the gaming establishment fund management system operate to transfer funds between the cashless wagering wallet and an EGM 106 or a gaming table component associated with a gaming table (not shown). In different examples, the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player of the EGM or a player at a gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and remote from a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and remote from a gaming table. For example, as seen in FIG. 1, the gaming establishment fund management system includes a second cashless wagering system (not shown) that maintains a sports wagering wallet 108 (e.g., a second cashless wagering account) which is in communication with the resort wallet 104, wherein such components of the gaming establishment fund management system operate to transfer funds between the sports wagering wallet and a gaming device configured to provide sports betting opportunities (not shown). In different embodiments, the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player remote from the gaming establishment, which operates with one or more components of the gaming establishment fund management system, to enable a user, such as a player remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a retail wallet 110 (e.g., a gaming establishment retail account) which is in communication with the resort wallet 104. In this example, to facilitate the transfer of funds from this gaming establishment retail account to an account associated with a retailer to purchase goods and/or services from the retailer, the system utilizes a retail wallet identity, such as a mobile device running a mobile device application that interfaces with a point-of-sale terminal 112 of a retail point-of-sale system of the retailer, and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

It should be appreciated that in various embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment fund management system is in communication with one or more external funding sources which maintain one or more external accounts for the user. For example, as seen in FIG. 1, the gaming establishment fund management system that maintains the resort wallet 104 is in communication with a network of one or more banks or other financial institutions (i.e., the banking networks 114) which operate to electronically transfer funds to/from the user's accounts maintained at such banks or financial institutions to/from one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any component or sub-system of the present disclosure can be in communication with one or more external funding sources. In different embodiments, the system utilizes any suitable interface, such as but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to facilitate the transfer of funds to/from a third-party account.

In certain embodiments, the gaming establishment fund management system is in communication with one or more credit systems which issue the user one or more lines of credit or markers. For example, as seen in FIG. 1, the gaming establishment fund management system that maintains the resort wallet 104 is in communication with a gaming establishment credit system (i.e., the casino credit system 116) to facilitate the activation of one or more lines of credit and the establishment of an amount of funds in the gaming establishment fund management account via such one or more lines of credits. In this example and as described below, to facilitate a transfer of funds from the line of credit issued by the credit system to an EGM and/or a credit balance of a gaming table component associated with a gaming table (or to a cashless wagering account) and then to a credit balance of an EGM and/or a credit balance of a gaming table component associated with a gaming table, the system utilizes any suitable interface, such as, but not limited to, a mobile device running a mobile device application, a kiosk, an EGM, a service window displayed by a gaming device (e.g., a remote host controlled service window displayed by an EGM), a component of a gaming establishment patron management system, such as a player tracking unit, and/or a gaming establishment interface to enable a user, such as a player of the EGM or a player at the gaming table, access to the issued line of credit. It should be appreciated that while illustrated as the gaming establishment fund management system being in communication with one or more gaming establishment credit systems, in different embodiments, any component or sub-system of the present disclosure can be in communication with one or more gaming establishment credit systems.

In certain embodiments, the gaming establishment credit system is in communication with one or more credit reporting/credit risk systems which monitor and report on various accounts associated with the user. For example, as seen in FIG. 1, the casino credit system 116 that offers lines of credits to gaming establishment patrons is in communication with one or more credit reporting and risk systems (i.e., the credit reporting/credit risk system 118). These credit reporting and risk systems monitor and report on a credit rating and status of one or more accounts maintained for the user at various funding sources, such as various financial institutions. It should be appreciated that any component or sub-system of the present disclosure can be in communication with one or more credit reporting/credit risk systems.

In certain embodiments, the gaming establishment credit system is in communication with one or more hotel systems which coordinate the reservations and stays of various patrons at a hotel associated with the gaming establishment. For example, as seen in FIG. 1, the casino credit system 116 that offers lines of credits to gaming establishment patrons is in communication with a hotel system 120 (including a hotel kiosk 122 and a hotel payment system 124 in communication with a banking network 126 of one or more banks or other financial institutions (that may be the same as or different from banking networks 114) that operate to electronically transfer funds to the hotel payment system to settle a user's hotel room folio with funds from the user's accounts maintained at such banks or financial institutions) to facilitate the opening of and settling of zero, one or more lines of credit. As seen in this example, the hotel system is also in communication with the gaming establishment fund management system (i.e., the resort wallet 104) to enable certain hotel charges to be monitored by and paid for with funds from one or more gaming establishment accounts maintained by the gaming establishment fund management system. It should be appreciated that any component or sub-system of the present disclosure can be in communication with one or more hotel systems.

In certain embodiments, the gaming establishment fund management system and the hotel system are each in communication with one or more gaming establishment patron management systems. For example, as seen in FIG. 1, the gaming establishment fund management system (i.e., resort wallet 104) and the hotel system (i.e., hotel system 120) are each in communication with one or more gaming establishment patron management systems (i.e., the casino patron system 128) that monitor activities at various points of contact associated with the gaming establishment and provides rewards, such as redeemable player tracking points, in association with such activities. It should be appreciated that any component or sub-system of the present disclosure can be in communication with one or more gaming establishment patron management systems.

### Issuing a Line of Credit

In certain embodiments, in addition to or alternative from enabling a user to establish the line of credit or marker with a gaming establishment credit system by applying for a line of credit (with or without presenting a check or other bank account information in the event the line of credit is not paid back by the user) and the credit system approving the line of credit for up to a set amount of funds, the system of the present disclosure enables a user to establish a line of credit or marker with a gaming establishment credit system in association with the user checking into a hotel of the gaming establishment. In these embodiments, upon an anticipated line of credit use event occurring in association with the user checking into a hotel of a gaming establishment (or otherwise occurring in association with one or more other activities, such as the user making reservations for a room at the hotel of the gaming establishment), a gaming establishment credit system operates with a hotel system to determine whether or not to offer a line of credit to the user independent of the user otherwise applying for the line of credit.

In certain such embodiments, when a user first checks into a hotel of a gaming establishment, the user will typically present a driver's license (or other form of identification) and a payment instrument, such as a credit card or debit card. The hotel system records this information such that the payment instrument may be charged at a later point in time to settle any outstanding charges (e.g., room service) on the hotel room folio at check-out. During this hotel check-in process, the hotel system (or a hotel system interface, such as a user interface running on a hotel check-in desk workstation or a hotel check-in kiosk) communicates with a gaming establishment credit system and requests the gaming establishment credit system for an authorization of a line of credit for the user being checked-in. In certain embodiments, in association with the request of the gaming establishment credit system to issue a line of credit for the user checking into the hotel, the gaming establishment credit system requires the user to sign or acknowledge certain terms and conditions of the applied for line of credit. It should be appreciated that since a user presents information to the hotel system upon checking into the hotel, the hotel system is already in possession of certain information required by the gaming establishment credit system, thereby eliminating the need for the user to reprovide such information to the gaming establishment credit system.

In certain embodiments, responsive to receiving the request to issue a line of credit for the user checking into the hotel, the gaming establishment credit system makes various determinations regarding the creditworthiness of the user and whether or not to issue the line of credit to the user. That is, prior to offering a line of credit as part of the hotel check-in process, the gaming establishment credit system determines whether to offer any credit to the user and if so, an amount of credit to offer to the user.

In one such embodiment, the gaming establishment credit system operates with a credit reporting/credit risk system to perform a credit check and determine how much credit, if any, to authorize to the user. In another such embodiment, the gaming establishment credit system additionally or alternatively operates with credit reporting/credit risk system to determine if the user has an outstanding line of credit at another gaming establishment. In this embodiment, to comply with certain jurisdictional regulations that prohibit the issuance of a line of credit at one gaming establishment to enable a user to pay debts at another gaming establishment, the gaming establishment credit system will deny the line of credit if the determination is that user has an outstanding amount owed on a line of credit at another gaming establishment.

In another such embodiment, the gaming establishment credit system additionally or alternatively operates with a gaming establishment employee management system to validate that the user checking into the hotel is not a hotel employee and/or a gaming establishment employee. In this embodiment, to comply with certain jurisdictional regulations that prohibit the issuance of a line of credit to hotel employees and/or gaming establishment employees, the gaming establishment credit system will deny the line of credit if the determination is that user checking into the hotel is a hotel employee or a gaming establishment employee.

In another such embodiment, the gaming establishment credit system additionally or alternatively operates with a responsible gaming system to validate that the user checking into the hotel has not previously opted out of participating in the gaming establishment line of credit program. In this embodiment, to comply with certain jurisdictional regulations that prohibit the issuance of a line of credit to anyone whom has opted out of participating in any line of credit programs, the gaming establishment credit system will deny the line of credit if the determination is that user checking into the hotel previously opted out of participating in the gaming establishment line of credit program.

In these embodiments, if the gaming establishment determines not to issue a line of credit to the user checking into the hotel, the gaming establishment credit system communicates a denial to the hotel system. In certain embodiments, following the denial, one or more display devices associated with the hotel system, such as user interface running on a hotel check-in desk workstation or hotel check-in kiosk display a denial of line of credit activation to the user or to a hotel employee (whom may notify the user of the denial of the line of credit).

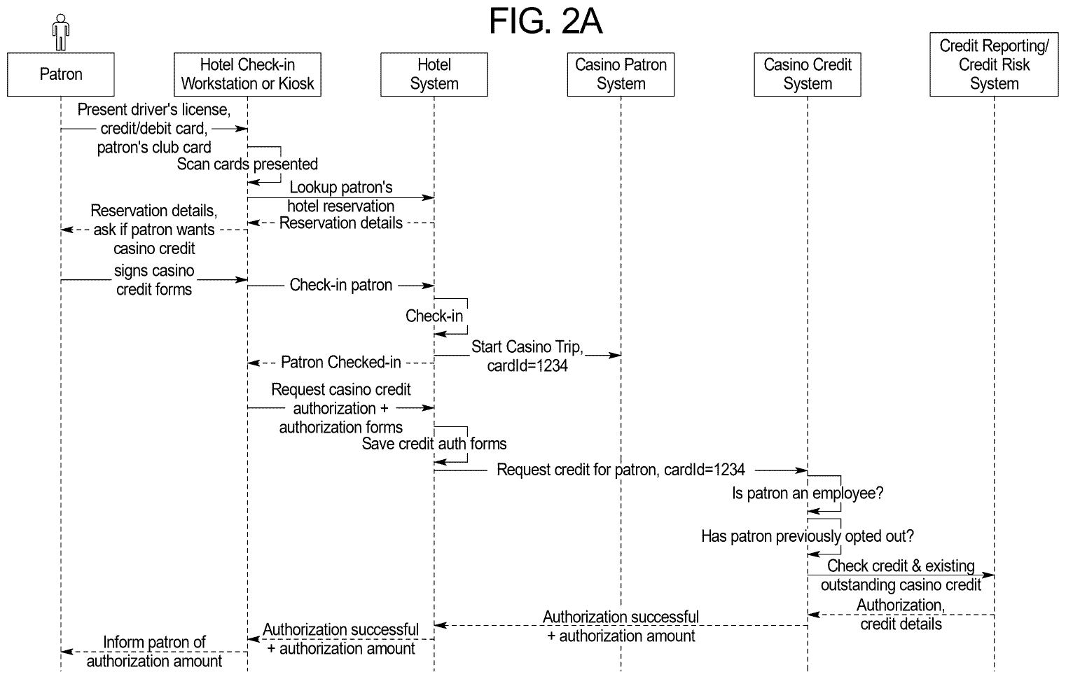

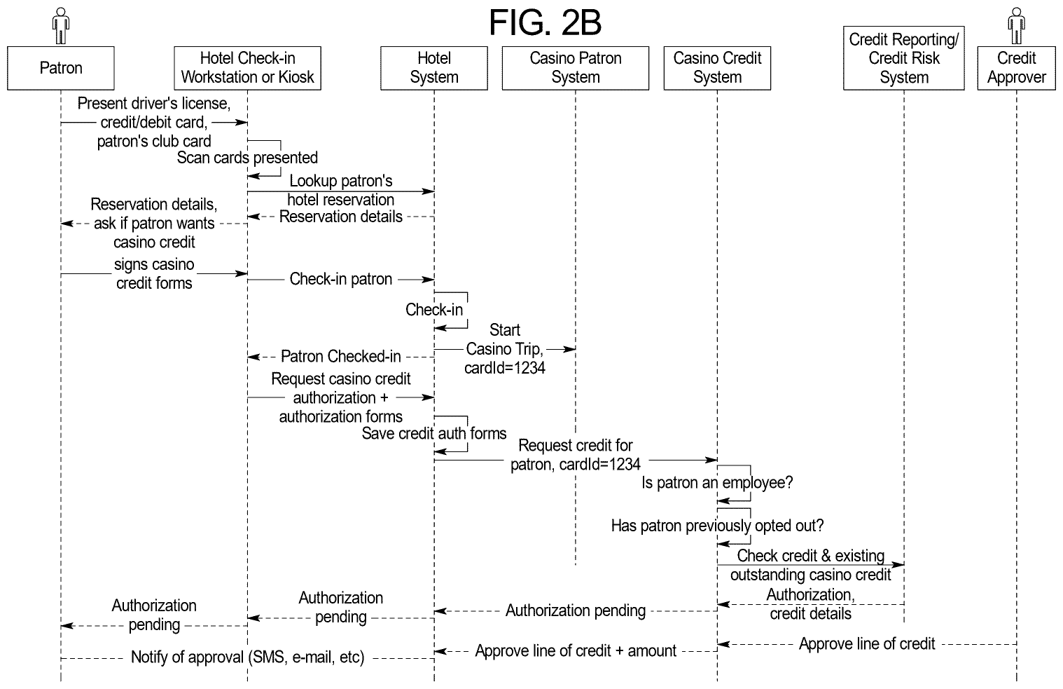

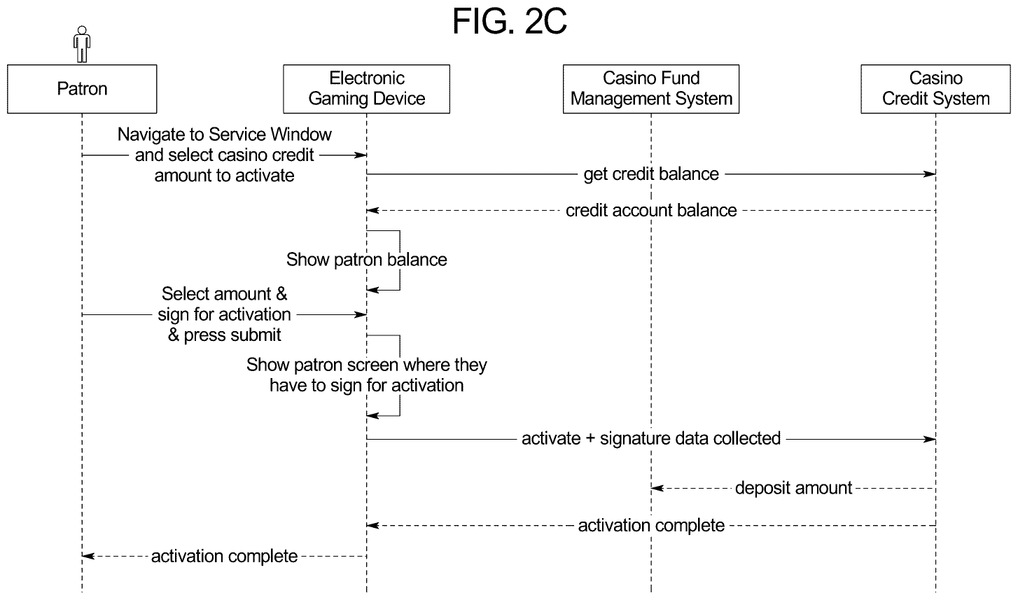

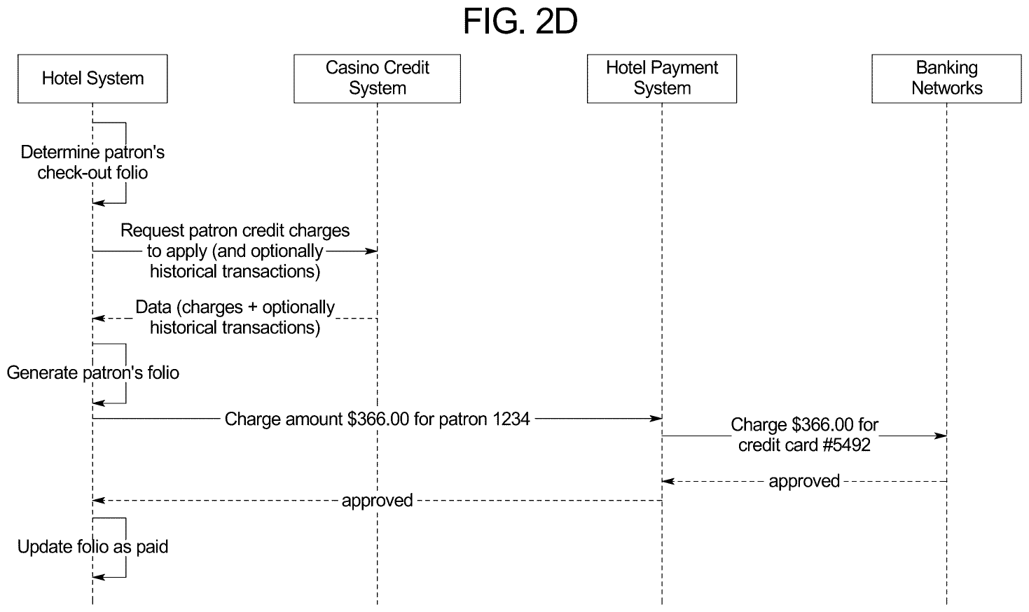

On the other hand, if the gaming establishment determines to issue a line of credit to the user checking into the hotel, then following an acknowledgement by the user of any required terms and conditions or other “in-writing” material associated with the line of credit, the gaming establishment credit system communicates a line of credit approval to the hotel system. In certain embodiments, following such an approval, one or more display devices associated with the hotel system, such as user interface running on a hotel check-in desk workstation or hotel check-in kiosk display an approval of line of credit activation to the user or a hotel employee (whom may notify the user of the approval of the line of credit). Accordingly, as seen in the example of FIG. 2A, a plurality of different components of the system of the present disclosure (e.g., a hotel check-in workstation or hotel check-in kiosk, a hotel system, a casino patron system, a casino credit system and a credit reporting/credit risk system) interact with each other to potentially offer a line of credit to a user in association with that user checking into a hotel of the casino. As such, in these embodiments, following the user checking into the hotel system, the hotel system operates with the credit system and zero, one or more other systems to automatically, subject to any user authorization, apply for and potentially issue a line of credit for the user as part of the user checking into a hotel of the gaming establishment.

In certain embodiments, in addition to operating with zero, one or more systems to determine whether or not to offer the user checking into the hotel a line of credit, the issuance of a line of credit to a user involves gaming establishment operator oversight. In these embodiments, for certain users, such as users with a questionable credit history (whom the gaming establishment may be reluctant to extend credit to without prior gaming establishment operator approval) and/or users with excellent credit history (whom the gaming establishment may want to extend additional credit to beyond the amount of credit approved by the gaming establishment credit system and/or whom the amount of credit approved by the gaming establishment credit system exceeds a threshold), the gaming establishment credit system requires gaming establishment operator approval prior to issuing or denying a line of credit. It should be appreciated that since the gaming establishment operator approval may occur after the user has checked into the hotel (and the user has left the hotel check-in desk or hotel check-in kiosk), upon the gaming establishment operator approving the line of credit, the system notifies the user via one or more of a displayed message at an EGM, a displayed message on a television or tablet in the user's hotel room, an email, a virtual assistant in the user's hotel room, a SMS text message, a notification displayed by a mobile device application, a phone call or in person (which may be useful for certain designated users, such as high rollers). Accordingly, as seen in the example of FIG. 2B, a plurality of different components of the system of the present disclosure (e.g., a hotel check-in workstation or hotel check-in kiosk, a hotel system, a casino patron system, a casino credit system and a credit reporting/credit risk system) interact with each other to potentially offer a line of credit to a user (subject to approval by a credit approver) in association with that user checking into a hotel of a casino. As such, in these embodiments, the gaming establishment hotel system operates with the gaming establishment credit system and zero, one or more other systems to automatically, subject to any user authorization, apply for and potentially issue, subject to gaming establishment personnel approval, a line of credit for the user as part of the user checking into a hotel of the gaming establishment.

In certain embodiments, as part of a user checking into a hotel of a gaming establishment, if the user is registered with a gaming establishment patron management system, such as a player tracking system, the user presents a physical instrument (e.g., a smart card or a user issued magnetic striped card), such as a player tracking card or presents a mobile device application running on a mobile device wherein the mobile device application is associated with the user's account with the gaming establishment patron management system. In certain other embodiments where the user is not registered with a gaming establishment patron management system, such as a player tracking system, the system associates the user checking into the hotel with an account of the gaming establishment patron management system. In these embodiments, since the user is providing certain information, such as information obtained from the user's driver license or other government issued identification, to the hotel system as part of the hotel check-in process, the hotel system communicates this information to the gaming establishment patron management system (which utilizes such information to open an account for the user). In one such embodiment, in association with the opening of the account, the user is provided a physical instrument associated with the gaming establishment patron management system account, such as via hotel personnel providing the user a player tracking card. In another such embodiment, the user is provided a code to activate their account and/or download a mobile identification (e.g., a mobile pass representing a player tracking card) via logging into a mobile device application associated with the gaming establishment or logging into a website associated with the gaming establishment. In another such embodiment, the user is sent an SMS text (and/or e-mail) informing the user how to activate their account and/or download a mobile identification via logging into a mobile device application associated with the gaming establishment or logging into a website associated with the gaming establishment.

In certain embodiments, as part of a user checking into a hotel of a gaming establishment, if the user is not associated with one or more gaming establishment accounts, such as a cashless wagering account, the system enrolls the user checking into the hotel with one or more accounts maintained by the gaming establishment fund management system. In these embodiments, since the user is providing certain information, such as information obtained from the user's driver license or other government issued identification, to the hotel system as part of the hotel check-in process, the hotel system communicates this information to the gaming establishment fund management system (which utilizes such information to open one or more gaming establishment accounts for the user). In one such embodiment, in association with the opening of the account, the user is provided a physical instrument associated with the gaming establishment fund management system account. In another such embodiment, the user is provided a code to activate their account and/or download a mobile identification via logging into a mobile device application associated with the gaming establishment or logging into a website associated with the gaming establishment. In another such embodiment, the user is sent an SMS text (and/or e-mail) informing the user how to activate their account and/or download a mobile identification via logging into a mobile device application associated with the gaming establishment or logging into a website associated with the gaming establishment.

Accordingly, by utilizing various information provided to a gaming establishment hotel system as part of a hotel check-in process, the system of the present disclosure streamlines the process of the opening of lines of credit and/or opening gaming establishment accounts. Such a configuration saves users time in not having to rekey in or reprovide the same information multiple times. Such a configuration also reduces potential errors in different data sets maintained by different systems (i.e., not requiring the duplication of providing the same information multiple times reduces the risks in inconsistencies in such information) thereby increasing operational efficiencies of the different systems employed.

### Utilizing Funds Activated from an Issued Line of Credit

In various embodiments, following the issuance of a line of credit, such as in association with a user checking into a hotel, the system enables the user to utilize an amount of funds to undertake one or more activities at the gaming establishment.

In certain embodiments, the system of the present disclosure enables a user at a gaming establishment device, such as an identified player at a gaming device (e.g., an EGM) or a consumer at a retail point-of-sale terminal, to make one or more inputs to cause a deposit of an amount of funds associated with an issued line of credit to the gaming establishment device. In these embodiments, utilizing a suitable interface, such as a user interface of an EGM, a user interface of a gaming table component associated with a gaming table, a kiosk, a point-of-sale terminal, a mobile device application being executed by a mobile device, a service window displayed by a gaming device (e.g., a remote host controlled service window displayed by an EGM), and/or a gaming establishment interface (e.g., a casino desk), the system enables the user to make one or more inputs to request a transfer of an amount of funds associated with the issued line of credit to the gaming establishment device. Such inputs include, but are not limited to, one or more inputs to indicate an amount of funds to be accessed from the line of credit, one or more inputs to approve the indicated amount of funds to be accessed from the line of credit, and/or one or more inputs to confirm the accessing of the line of credit. It should be appreciated that certain jurisdictional regulations and/or gaming establishment policies require the user to approve their transaction to access the funds on their issued line of credit. In one such embodiment, the user acknowledges the approval of accessing the issued line of credit by entering a personal identification number (“PIN”) via the user interface, providing a signature and/or presenting a biometric identifier to the employed user interface.

In various embodiments, following receipt of the user inputted data associated with the determined amount of funds to be accessed from the issued line of credit and a confirmation from the user that they approve of the transaction and agree to any terms associated with the transaction, the gaming establishment device (or a mobile device application paired with the gaming establishment device or a component associated with the gaming establishment device, such as a slot machine interface board (“SMIB”) of an EGM) communicates one or more messages to the gaming establishment credit system to log the user into the gaming establishment credit system (if necessary) and request a transfer of the amount of funds to be accessed from the issued line of credit of the user. Upon receiving the messages from the gaming establishment device (or a mobile device application paired with the gaming establishment device or a component associated with the gaming establishment device) and verifying the request, the gaming establishment credit system determines whether to authorize the activation of the determined amount of funds from the issued line of credit. In these embodiments, if the gaming establishment credit system determines not to authorize the activation of the determined amount of funds from the issued line of credit (e.g., the gaming establishment credit system determines that the requested amount exceeds the maximum amount available under the issued line of credit), the gaming establishment credit system communicates a denial to the gaming establishment device (or a mobile device application paired with the gaming establishment device or a component associated with the gaming establishment device). In certain embodiments, following the denial, one or more display devices associated with the gaming establishment device (or a mobile device application paired with the gaming establishment device or a component associated with the gaming establishment device) display a denial of line of credit fund transfer to the user.

On the other hand, if the gaming establishment credit system determines to authorize the transfer of the determined amount of funds from the issued line of credit, the gaming establishment credit system updates the amount available of the issued line of credit and communicates an authorization of the requested amount of funds to the gaming establishment device. Upon receiving the authorization, the gaming establishment device updates a balance of the gaming establishment device by the requested amount of funds activated from the line of credit. Additionally, the gaming establishment credit system updates an outstanding line of credit balance to reflect the amount of funds transferred to the gaming establishment device in association with the line of credit. In certain embodiments, in association with the transfer of an amount of funds associated with the line of credit, the system communicates a transfer of funds confirmation, wherein one or more display devices associated with the gaming establishment device (or a mobile device application paired with the gaming establishment device or a component associated with the gaming establishment device) display a confirmation of the transfer of the amount of funds from the line of credit to the gaming establishment device.

In certain other embodiments, rather than transferring funds from a line of credit directly to a gaming establishment device, the system of the present disclosure enables a user at a gaming establishment device, such as an identified player at a gaming device (e.g., an EGM) or a consumer at a retail point-of-sale terminal, to make one or more inputs to cause a deposit of an amount of funds associated with an issued line of credit into a gaming establishment account and further enables the user to make one or more inputs to initiate a transfer of funds from the gaming establishment account to the gaming establishment device.

In certain embodiments, if a user wants to access the funds associated with a line of credit or marker at a gaming establishment device, then following the above-described establishment of the line of credit or marker with a gaming establishment credit system, the user pairs or links a mobile device with the gaming establishment device, wherein, as described below, this pairing or linkage between the mobile device and the gaming establishment device occurs via one or more applications being run or executed on the mobile device. It should be appreciated that described below as utilizing a mobile device application to cause a deposit of an amount of funds associated with an issued line of credit into a gaming establishment account and to initiate a transfer of funds from the gaming establishment account to the gaming establishment device, any suitable interface, such as a user interface of an EGM, a user interface of a gaming table component associated with a gaming table, a kiosk, a point-of-sale terminal, a service window displayed by a gaming device (e.g., a remote host controlled service window displayed by an EGM), and/or a gaming establishment interface (e.g., a casino desk) may be utilized to cause a deposit of an amount of funds associated with an issued line of credit into a gaming establishment account and to initiate a transfer of funds from the gaming establishment account to the gaming establishment device.

In certain embodiments, the system utilizes one mobile device application to interact with the different components of the gaming establishment fund management system to access funds maintained in the different gaming establishment accounts associated with the user and/or to access funds associated with one or more lines of credit or markers issued to the user. For example, utilizing the same mobile application, a mobile device interacts with both the first cashless wagering system of the gaming establishment fund management system and the credit system in communication with the gaming establishment fund management system. In certain embodiments, the system utilizes multiple mobile device applications to interact with the different components of the gaming establishment fund management system to access funds maintained in the different gaming establishment accounts associated with the user and/or to access funds associated with one or more lines of credit or markers issued to the user or more lines of credit or markers issued to the user.

In certain embodiments, the mobile device application which interacts with one or more components of the gaming establishment fund management system includes a location based digital wallet enabled application, such as a Passbook-enabled or Wallet-enabled application, which is accessible when the user enters a gaming establishment. In certain embodiments, the mobile device application which interacts with one or more components of the gaming establishment fund management system is downloaded to the mobile device from an application store. In certain such embodiments, the mobile device application is downloaded to the mobile device from one or more websites affiliated with the gaming establishment (which are accessible directly by the user and/or by a link opened when the user scans a QR code).

Following the pairing between the mobile device and the gaming establishment device (or a component associated with the gaming establishment device, such as a SMIB associated with an EGM), the system enables the user to utilize a mobile device to view information about one or more issued lines of credit (e.g., an available amount of funds associated with the issued line of credit and/or an amount of funds associated with the issued line of credit previously accessed) as well as the balance of zero, one or more gaming establishment accounts. In these embodiments, the system additionally enables the user to activate all or part of the available amount of funds associated with the issued line of credit. That is, the system enables the user to access the issued line of credit from the mobile device application wherein the accessed amount of funds are transferred to a gaming establishment account associated with the user, such as the user's cashless wagering account and then transferred to a gaming establishment device. In these embodiments, via interfacing with the mobile device application (or alternatively the gaming establishment device or a component associated with the gaming establishment device), the system enables the player to make one or more inputs regarding the requested access to the line of credit, such as, but not limited to, one or more inputs to indicate an amount of funds to be accessed from the line of credit, one or more inputs to approve the indicated amount of funds to be accessed from the line of credit, and/or one or more inputs to confirm the accessing of the line of credit.

In various embodiments, following receipt of the user inputted data associated with the determined amount of funds to be accessed from the issued line of credit and a confirmation from the user that they approve of the transaction and agree to any terms associated with the transaction, such as via entering a PIN or providing a signature, the mobile device application (and/or the gaming establishment device or a component associated with the gaming establishment device) communicates one or more messages to the gaming establishment credit system to log the user into the gaming establishment credit system (if necessary) and request an activation of the amount of funds to be accessed from the issued line of credit of the user. Upon receiving the messages from the mobile device application (and/or the gaming establishment device or the component associated with the gaming establishment device) and verifying the request, the gaming establishment credit system proceeds with operating with the gaming establishment fund management system or a component of the gaming establishment fund management system, such as a cashless wagering system, to log the user into a gaming establishment account associated with the user (if necessary) and potentially transfer the amount of funds to be accessed from the issued line of credit of the user to the gaming establishment account associated with the user, such as to a cashless wagering account associated with the user. Accordingly, as seen in the example of FIG. 2C, a plurality of different components of the system of the present disclosure (e.g., an EGM (or a SMIB associated with the EGM), a casino fund management system and a casino credit system) interact with each other to enable a patron, such as a player at an EGM, to activate an amount of funds deposited into a gaming establishment account (for future transfer to a gaming establishment device).

In certain embodiments, to complete a transfer of an amount of funds associated with a line of credit to a gaming establishment account, the gaming establishment credit system determines whether to authorize the activation of the determined amount of funds from the issued line of credit. In these embodiments, if the gaming establishment credit system determines not to authorize the activation of the determined amount of funds from the issued line of credit (e.g., the gaming establishment credit system determines that the requested amount exceeds the maximum amount available under the issued line of credit), the gaming establishment credit system communicates a denial to the mobile device application (and/or the gaming establishment device or a component associated with the gaming establishment device). In certain embodiments, following the denial, one or more display devices associated with the mobile device (and/or the gaming establishment device or a component associated with the gaming establishment device) display a denial of line of credit activation to the user.

On the other hand, if the gaming establishment credit system determines to authorize the activation of the determined amount of funds from the issued line of credit, the gaming establishment credit system updates the amount available of the issued line of credit and communicates an authorization of the requested amount of funds to the gaming establishment fund management system. Upon receiving the authorization, the gaming establishment fund management system updates a balance of a gaming establishment account by the requested amount of funds activated from the line of credit. Additionally, upon receiving the authorization, the gaming establishment fund management system and/or the gaming establishment credit system updates an outstanding line of credit balance to reflect the amount of funds activated from the line of credit. In certain embodiments, in association with the transfer of an amount of funds associated with activated line of credit and the corresponding increase of the outstanding line of credit balance, the system communicates a transfer of funds confirmation, wherein one or more display devices associated with the mobile device (and/or the gaming establishment device or a component associated with the gaming establishment device) display a confirmation of the transfer of the amount of funds from the line of credit to the gaming establishment account.

In certain embodiments, following the completion of the transfer of an amount of funds associated with the line of credit to the gaming establishment account, such as a cashless wagering account associated with a user, the system enables the user to utilize a mobile device application to facilitate a transfer of an amount of funds from the gaming establishment account to a gaming establishment device, such as an EGM, a retail point-of-sale terminal or a gaming table component associated with a gaming table. In certain embodiments, the mobile device application enables the user to input an amount of funds to be transferred to the gaming establishment device, wherein the amount of funds may be part of or all of the amount accessed from the line of credit.

In certain embodiments, following the determination of an amount of funds to be transferred from the gaming establishment account, such as the cashless wagering account, to the gaming establishment device, the mobile device application prompts the user to cause the mobile device to engage the gaming establishment device or a component associated with the gaming establishment device, such as prompting the user to tap the mobile device to a player tracking card reader or other designated location(s) of an EGM. After such engagement (or after the determination of an amount of funds to be transferred if no mobile device to gaming establishment device engagement is required), the mobile device application communicates, via a wireless communication protocol (including, but not limited to: Bluetooth™, Bluetooth™ Low Energy (“BLE”), one or more cellular communication standards (e.g., 3G, 4G, 5G, LTE), one or more Wi-Fi compatible standards, and one or more short range communication protocols (e.g., a near field communication (“NFC”) protocol), data associated with the determined amount of funds to be transferred from the gaming establishment account to the gaming establishment device. For example, wherein the transfer of funds is from a cashless wagering account, the EGM (or a component associated with the EGM, such as a SMIB and/or the mobile device application) proceeds with operating with a cashless wagering system to log the player into a cashless wagering account associated with the player (if necessary) and request the determined amount of funds to be transferred from the cashless wagering account to the EGM.

Following the mobile device application interacting with the gaming establishment device to facilitate the request of the determined amount of funds, the gaming establishment fund management system (or a component of the gaming establishment fund management system, such as the cashless wagering system), determines whether to authorize the transfer of the determined amount of funds. If the component of the gaming establishment fund management system determines not to authorize the determined amount of funds, the component of the gaming establishment fund management system communicates a denial to the gaming establishment device and/or the mobile device application, wherein the gaming establishment device and/or mobile device application display a denial of funds transfer to the user.

On the other hand, if the component of the gaming establishment fund management system determines to authorize the determined amount of funds, the component of the gaming establishment fund management system updates the gaming establishment account associated with the user and communicates an authorization to the gaming establishment device. For example, when funds are being transferred from a cashless wagering account to the EGM, the cashless wagering system reduces a balance of the cashless wagering account by the reduced amount of funds. The EGM proceeds with updating a credit balance of the EGM to account for the determined amount of funds. In certain embodiments, the gaming establishment device further proceeds with communicating a transfer of funds confirmation to the mobile device, wherein the mobile device application displays a confirmation of the transfer of the amount of funds and/or the updated credit balance of the gaming establishment device. Such a transferred amount of funds is then available for wagering by the player at the EGM.

It should be appreciated that in different embodiments, in addition to or alternatively from utilizing a mobile device running a mobile device application to access funds maintained in the different gaming establishment accounts associated with the user and/or to access funds associated with one or more lines of credit or markers issued to the user, the system utilizes a kiosk, a gaming establishment device, such as an EGM, a gaming table component associated with a gaming table, or a point-of-sale terminal, a service window displayed by a gaming device (e.g., a remote host controlled service window displayed by an EGM), a component of a gaming establishment patron management system, such as a player tracking unit, and/or a gaming establishment interface, such as a casino desk, to access funds maintained in the different gaming establishment accounts associated with the user and/or to access funds associated with one or more lines of credit or markers issued to the user. It should be further appreciated that in addition to or alternative of using a mobile device running a mobile device application to access funds maintained in the different gaming establishment accounts associated with the user and/or to access funds associated with one or more lines of credit or markers issued to the user, a physical instrument, such as a smart card or a user issued magnetic striped card may additionally or alternatively be utilized to enable a user access to such gaming establishment accounts, and/or to access funds associated with one or more lines of credit issued to the user.

In certain embodiments, the outstanding line of credit balance is maintained by the gaming establishment fund management system (or a component of the gaming establishment fund management system, such as a cashless wagering system) and updated responsive to transfers between the gaming establishment fund management system and the gaming establishment credit system. In certain embodiments, the outstanding line of credit balance is maintained by the gaming establishment credit system and determined by the gaming establishment fund management system by a request to the gaming establishment credit system.

It should be appreciated that the mobile device facilitated fund data transfers of the present disclosure may occur in addition to or as an alternative from cash-based fund transfers and/or ticket voucher-based fund transfers. In one such embodiment, an amount of funds transferred to a gaming establishment device is funded via any of a mobile device facilitated fund transfer, a cash-based fund transfer or a ticket voucher-based fund transfer. In another embodiment, an amount of funds transferred from a gaming establishment device is cashed out via any of a mobile device facilitated fund transfer, a cash-based fund transfer or a ticket voucher-based fund transfer. In another embodiment, an amount of funds transferred to a gaming establishment device is funded via a mobile device facilitated fund transfer or a cash-based fund transfer (but is not funded via any ticket voucher-based fund transfer). In another embodiment, an amount of funds transferred from a gaming establishment device is cashed out via a mobile device facilitated fund transfer or a cash-based fund transfer (but is not cashed out via any ticket voucher-based fund transfer). In another embodiment, an amount of funds transferred to a gaming establishment device is funded via a mobile device facilitated fund transfer or a ticket voucher-based fund transfer (but is not funded via any cash-based fund transfer). In another embodiment, an amount of funds transferred from a gaming establishment device is cashed out via a mobile device facilitated fund transfer or a ticket voucher-based fund transfer (but is not cashed out via any cash-based fund transfer). In another embodiment, an amount of funds transferred to a gaming establishment device is funded via a mobile device facilitated fund transfer (but is not funded via a cash-based fund transfer nor a ticket voucher-based fund transfer). In another embodiment, an amount of funds transferred from a gaming establishment device is cashed out via a mobile device facilitated fund transfer (but is not cashed out via a cash-based fund transfer nor a ticket voucher-based fund transfer).

### Settling Funds from an Issued Line of Credit

In various embodiments, following a user activating an amount of funds associated with an issued line of credit, the system monitors for an occurrence of a line of credit settlement event. In these embodiments, upon a line of credit settlement event, such as a gaming establishment patron checking out of a hotel of a gaming establishment, the system operates with one or more gaming establishment components to pay back part or all of the amount of outstanding funds associated with the line of credit using a designated payment instrument, such as the credit card or debit card used to settle any outstanding charges on the hotel bill. In these embodiments, when a user attempts to check-out of a hotel of a gaming establishment (or otherwise settle the amount of outstanding funds on a line of credit in association with a gaming establishment hotel system), the gaming establishment hotel system operates with the gaming establishment credit system to determine if the user is associated with an outstanding amount of funds activated from an issued line of credit. If the gaming establishment credit system determines that the user is associated with an outstanding amount of funds activated from an issued line of credit, the gaming establishment credit system operates with the gaming establishment hotel system to enable the user to pay off part or all of the outstanding amount of funds activated from the issued line of credit as part of the payment of the user's hotel room folio. Accordingly, to mitigate the risk that a user with an outstanding line of credit liability will not satisfy such a liability, the system of the present disclosure incorporates the settlement of an outstanding line of credit liability with the settlement of an outstanding gaming establishment hotel liability to provide a more streamlined and efficient process relating to lines of credits.

Specifically, in certain embodiments, following a user utilizing an amount of funds associated with a line of credit, the system monitors for an occurrence of a line of credit settlement event in the form of the user checking out of a hotel of the gaming establishment. In these embodiments, upon the user attempting to check-out of the hotel (or upon an automatic checking out process of the hotel on the user's check-out day), the hotel system communicates one or more messages to the gaming establishment credit system to log the user into the gaming establishment credit system (if necessary) and obtain information regarding the line of credit liability. That is, at one or more designated intervals, such as periodically, whenever an activation of an amount of funds from a line of credit are activated or as part of the process of determining the user's hotel room folio (for checking out of the hotel and/or to present to the user the current hotel room folio if they were to presently check out of the hotel), the hotel system contacts the gaming establishment credit system to determine information about any line of credit transactions, any fees to be applied, and/or any outstanding line of credit liability.

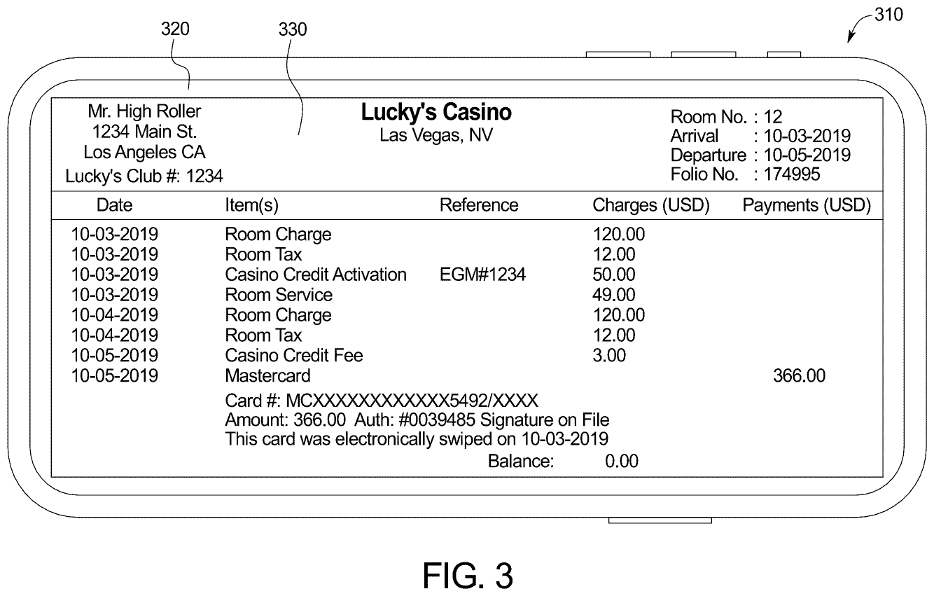

Following the gaming establishment credit system providing the hotel system information regarding the line of credit liability of the user, the hotel system compiles a current amount owed including charges pertaining to the user's activities funded with the line of credit and the user's activities charged to the user's hotel room. In such embodiments, the hotel room folio includes various line items regarding the hotel activities undertaken by the user independent of any issued lines of credit (e.g., hotel room charges, room tax charges, resort fees, room service fees, food & beverage fees, and any sales taxes) as well as various line items regarding the activities funded by the line of credit undertaken by the user (e.g., an amount of an outstanding line of credit liability, an amount of any line of credit fees or convenience charges, and for each transaction when the line of credit was accessed, a line of credit access amount, a date and/or time of access of the line of credit and/or a touchpoint where the user accessed the line of credit). For example, as seen in FIG. 3, the gaming establishment credit system operates with the hotel system to include line of credit transactions on the hotel room folio which is then accessible by a mobile device application 320 of a mobile device 310 to enable the user to view a hotel room folio 330 including charges pertaining to the user's activities funded with the line of credit and the user's activities charged to the user's hotel room.

After determining the current amount owed including charges pertaining to the user's activities funded with the line of credit and the user's activities charged to the user's hotel room, the hotel system (or a component of the hotel system, such as a hotel payment system) attempts to pay off the line of credit liability as well as other charges owed to the hotel with the payment instrument provided at hotel check-in, such as a credit card or debit card. If the hotel system (or the component of the hotel system, such as the hotel payment system) is unable to pay off the amount owed on the hotel room folio with the payment instrument (e.g., the amount owed on the hotel room folio exceeds the credit limit on the user's credit card), the hotel system communicates one or more messages to the gaming establishment credit system which maintains the outstanding line of credit liability. On the other hand, if the hotel system (or the component of the hotel system, such as the hotel payment system) successfully pays off the amount owed on the hotel room folio with the payment instrument, the hotel system notifies the gaming establishment credit system which updates the outstanding line of credit balance (to reflect a paying off of part or all of the issued line of credit). Accordingly, as seen in the example of FIG. 2D, a plurality of different components of the system of the present disclosure (e.g., a hotel system, a casino credit system, and a hotel payment system) interact with each other and one or more banking networks to potentially settle a line of credit of a user in association with that user checking out of a hotel of the casino.

It should be appreciated that in settling an outstanding line of credit liability as part of settling an outstanding gaming establishment hotel liability enables the user to employ one or more payment instruments not otherwise available to settle (or otherwise cost prohibitive in settling) an outstanding line of credit liability in isolation. That is, in recognition of at least the MCC mechanisms which prevent a user from paying off the funds accessed from a line of credit with a credit card or debit card, the system of the present disclosure enables the user to pay off the funds accessed from a line of credit at a gaming establishment hotel check-out using any payment instrument, including, but not limited to, credit cards and debit cards, wherein such charges are relatively highly unlikely to be denied by the financial institutions associated with such payment instruments and also relatively unlikely to be treated as cash advances by such financial institutions. Such a configuration enables a gaming establishment patron's line of credit to be reconciled at hotel checkout and charged to their hotel room folio to enable the gaming establishment patron to settle any amounts owed on an activated line of credit using any payment instrument, such as a credit card or debit card, wherein regardless of the payment instrument employed, a non-gambling MCC is employed for the charge. Put differently, the system of the present disclosure expands the scope of hotel guest lines of credit to also include a gaming establishment line of credit that can be leveraged at any touchpoint within the gaming establishment during the hotel guest's stay.

In certain embodiments, to account for different payment instruments provided at hotel check-in having different attributes and/or limits to amounts which may be used in different channels of commerce associated with a gaming establishment, the system monitors a user's spend at the gaming establishment and takes one or more actions if certain conditions are satisfied. In one such embodiments, the system tracks a ratio of gaming to non-gaming hotel account expenses for a user (or for a credit card issuer) and limits certain activities if the ratio falls outside of a range of designated ratios. For example, since the system is aware that a user provided (during the hotel check-in process) a credit card with a maximum gaming to non-gaming ratio of 50%, the system limits the user to less than 50% gaming charges. In another example, the system tracks an absolute dollar amount and limits the use of gaming charges to a credit card to less than the absolute dollar amount.

In certain embodiments, as part of monitoring a user's spend at the gaming establishment, the system notifies the user if the system determines that the user must spend more funds at the gaming establishment on non-gaming activities to increase the line of credit available for gaming activities at the gaming establishment. For example, upon determining that a user has $1000 in gaming spending and $1000 in hotel and dining expenses and further upon determining that the user's credit card permits a 50% limit on the ratio of non-gaming spending to gaming spending, the system notifies the user of this ratio and suggests options for the user, such as using a mobile device application or a service window displayed by an EGM to display messages such as “visit the restaurant to get more gaming credit” or “Spend $200 at the steakhouse and get $100 more in gaming charges”. In these embodiments, following the user taking one or more activities to modify the current ratio of non-gaming spending to gaming spending, the system notifies the user of the modified amount of the line of credit usable for gaming. For example, following a user visiting a spa and spending $240, the system notifies the user that the user's gaming credit line has increased by $120.

In certain embodiments, the system enables a gaming establishment operator to assign a value to a user and enable the user to exceed the limits or assign new limits to the user. For example, if a user's credit card permits a 50% limit on non-gaming spend to gaming spend, following the system determining, such as based on information received from a gaming establishment patron management system, that the user is a valued customer, the system enables the gaming establishment operator to modify the ratio of non-gaming spend to gaming spend to up to 60% (or to exceed the 50% limit by $1000). In certain instances, the gaming establishment operator temporarily absorbs the additional extended credit in the hopes of getting the user as a return customer. For example, if a user has $1500 in gaming charges and $1000 in hotel charges, at check-out the gaming establishment absorbs the $500 in hopes of getting the user to return to the gaming establishment. In another embodiment, the system enables the user to exceed the credit card limit by agreeing to a loan or paying by other methods (cash, check, etc.) at a later time. For example, when a user with $1500 in gaming charges and $1000 in hotel charges checks out of the hotel, the system charges $2000 to the user's credit card and asks the user to pay the $500 by cash or check. In variations of these embodiments, the ratio or dollar amount limits employed are scalable for different users, such as by providing that users with higher player tracking account statuses have higher ratios or dollar amount limits (compared to users with lower player tracking account statuses).

In certain embodiments, the hotel system tracks more than one payment instrument associated with a user and is aware of any rules associated with that payment instrument. In these embodiments, the hotel system coordinates the use of such payment instruments to maximize the benefits of the user. For example, a user may have two credit cards on file, where the first credit card permits up to 50% gaming spend for the Hotel MCC code, and the second credit card permits up to $500 of hotel spend on a given charge. In this example, the hotel system (or other component responsible for determining the final hotel room folio and charging the user's on file payment methods, such as a hotel payment system), splits the charges for the user's stay across one or more of the cards on file for the user so that the charges meet the limits or rules associated with each payment instrument.

In certain embodiments, the system operates to notify the user about the benefits of charging funds owed on a line of credit to one or more credit cards on file with the gaming establishment, such as one or more credit cards provided during the check-in process at the hotel. For example, if a user has a 2% cash back credit card on file (or if the gaming establishment has partnered with a credit card company offering such a card), then the gaming establishment notifies the user through one of many communications channels (e.g., e-mail, SMS/text, iMessage, in-person communications) that they are allowed to spend (or may be allowed to spend) up to $1000 of funds from a line of credit on gaming activities during their trip to a gaming establishment and that they would get 2% cash back if they used the payment instrument which supports this type of incentive.

It should be appreciated that any functionality or process of the present disclosure may be implemented via one or more servers, one or more gaming establishment devices, one or more components of a gaming establishment device (such as a component of a gaming establishment management system (e.g., a player tracking unit) supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers.

In certain embodiments, the above-described embodiments of the present disclosure may be implemented in accordance with or in conjunction with zero, one or more components of a gaming establishment fund management system (e.g., a cashless wagering system), zero, one or more components of a gaming establishment patron management system, zero, one or more components of a gaming establishment hotel system (e.g., a hotel check-in kiosk or a hotel check-in desk workstation), zero, one or more components of a retail point-of-sale system and/or zero, one or more gaming establishment devices, such as an EGM or a point-of-sale terminal. In these embodiments, such components of the gaming establishment fund management system, the gaming establishment patron management system, the gaming establishment hotel system, the retail point-of-sale system and/or the gaming establishment device each include a controller including at least one processor. The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the gaming establishment patron management system, the component of the gaming establishment hotel system, the component of the retail point-of-sale system and/or the gaming establishment device; (3) accessing memory to configure or reconfigure parameters in the memory according to indicia read from the component of the gaming establishment fund management system, the component of the gaming establishment patron management system, the component of the gaming establishment hotel system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the gaming establishment patron management system, the component of the gaming establishment hotel system, the component of the retail point-of-sale system and/or the gaming establishment device, while in other embodiments, at least one component of the controller resides outside of the housing of the component of the gaming establishment fund management system, the component of the gaming establishment patron management system, the component of the gaming establishment hotel system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the gaming establishment patron management system, the component of the gaming establishment hotel system, the component of the retail point-of-sale system and/or the gaming establishment device disclosed herein. In certain embodiments, the at least one memory device resides within the housing of the component of the gaming establishment fund management system, the component of the gaming establishment patron management system, the component of the gaming establishment hotel system, the component of the retail point-of-sale system and/or the gaming establishment device, while in other embodiments at least one component of the at least one memory device resides outside of the housing of the component of the gaming establishment fund management system, the component of the gaming establishment patron management system, the component of the gaming establishment hotel system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the gaming establishment patron management system, the component of the gaming establishment hotel system, the component of the retail point-of-sale system and/or the gaming establishment device; (2) associations between configuration indicia read from a component of the gaming establishment fund management system with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the gaming establishment patron management system, the component of the gaming establishment hotel system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the gaming establishment patron management system, the component of the gaming establishment hotel system, the component of the retail point-of-sale system and/or the gaming establishment device to control the component of the gaming establishment fund management system, the component of the gaming establishment patron management system, the component of the gaming establishment hotel system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the gaming establishment patron management system, the component of the gaming establishment hotel system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the gaming establishment patron management system, the component of the gaming establishment hotel system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the gaming establishment patron management system, the component of the gaming establishment hotel system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the gaming establishment patron management system, the component of the gaming establishment hotel system, the component of the retail point-of-sale system and/or the gaming establishment device loads the new device driver from the at least one memory device to enable communication with the new device. For instance, one type of card reader in the component of the gaming establishment fund management system, the component of the gaming establishment patron management system, the component of the gaming establishment hotel system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the gaming establishment patron management system, the component of the gaming establishment hotel system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the gaming establishment patron management system, the component of the gaming establishment hotel system, the component of the retail point-of-sale system and/or the gaming establishment device. In various embodiments, the display devices serve as digital glass configured to aspects of the gaming establishment in which the component of the gaming establishment fund management system, the component of the gaming establishment patron management system, the component of the gaming establishment hotel system, the component of the retail point-of-sale system and/or the gaming establishment device is located. In various embodiments, the component of the gaming establishment fund management system, the component of the gaming establishment patron management system, the component of the gaming establishment hotel system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the gaming establishment patron management system, the component of the gaming establishment hotel system, the component of the retail point-of-sale system and/or the gaming establishment device receives an actuation, the component of the gaming establishment fund management system, the component of the gaming establishment patron management system, the component of the gaming establishment hotel system, the component of the retail point-of-sale system and/or the gaming establishment device causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the gaming establishment patron management system, the component of the gaming establishment hotel system, the component of the retail point-of-sale system and/or the gaming establishment device provides dynamic sounds coupled with attractive multimedia images displayed on one or more of the display devices to provide an audio-visual representation or to otherwise display full-motion video with sound to attract players to the component of the gaming establishment fund management system, the component of the gaming establishment patron management system, the component of the gaming establishment hotel system, the component of the retail point-of-sale system and/or the gaming establishment device. In certain embodiments, the component of the gaming establishment fund management system, the component of the gaming establishment patron management system, the component of the gaming establishment hotel system, the component of the retail point-of-sale system and/or the gaming establishment device displays a sequence of audio and/or visual attraction messages during idle periods to attract potential players to the component of the gaming establishment fund management system, the component of the gaming establishment patron management system, the component of the gaming establishment hotel system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the gaming establishment patron management system, the component of the gaming establishment hotel system, the component of the retail point-of-sale system and/or the gaming establishment device. In one embodiment, the at least one input device includes a payment device configured to communicate with the at least one processor of the component of the gaming establishment fund management system, the component of the gaming establishment patron management system, the component of the gaming establishment hotel system, the component of the retail point-of-sale system and/or the gaming establishment device to fund the component of the gaming establishment fund management system, the component of the gaming establishment patron management system, the component of the gaming establishment hotel system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the gaming establishment patron management system, the component of the gaming establishment hotel system, the component of the retail point-of-sale system and/or the gaming establishment device to be funded via an electronic funds transfer, such as a transfer of funds from a bank account. In another embodiment, the component of the gaming establishment fund management system, the component of the gaming establishment patron management system, the component of the gaming establishment hotel system, the component of the retail point-of-sale system and/or the gaming establishment device includes a payment device configured to communicate with a mobile device of a player, such as a mobile phone, a radio frequency identification tag, or any other suitable wired or wireless device, to retrieve relevant information associated with that player to fund the component of the gaming establishment fund management system, the component of the gaming establishment patron management system, the component of the gaming establishment hotel system, the component of the retail point-of-sale system and/or the gaming establishment device. When the component of the gaming establishment fund management system, the component of the gaming establishment patron management system, the component of the gaming establishment hotel system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the gaming establishment patron management system, the component of the gaming establishment hotel system, the component of the retail point-of-sale system and/or the gaming establishment device operator to, when actuated, cause the component of the gaming establishment fund management system, the component of the gaming establishment patron management system, the component of the gaming establishment hotel system, the component of the retail point-of-sale system and/or the gaming establishment device to perform particular functions. For instance, such buttons may be hard keys, programmable soft keys, or icons icon displayed on a display device of the component of the gaming establishment fund management system, the component of the gaming establishment patron management system, the component of the gaming establishment hotel system, the component of the retail point-of-sale system and/or the gaming establishment device that are actuatable via a touch screen of the component of the gaming establishment fund management system, the component of the gaming establishment patron management system, the component of the gaming establishment hotel system, the component of the retail point-of-sale system and/or the gaming establishment device or via use of a suitable input device of the component of the gaming establishment fund management system, the component of the gaming establishment patron management system, the component of the gaming establishment hotel system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the gaming establishment patron management system, the component of the gaming establishment hotel system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the gaming establishment patron management system, the component of the gaming establishment hotel system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the gaming establishment patron management system, the component of the gaming establishment hotel system, the component of the retail point-of-sale system and/or the gaming establishment device, such as one or more rechargeable power sources (e.g., rechargeable batteries) located at the component of the gaming establishment fund management system, the component of the gaming establishment patron management system, the component of the gaming establishment hotel system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the gaming establishment patron management system, the component of the gaming establishment hotel system, the component of the retail point-of-sale system and/or the gaming establishment device; detecting the presence and/or identity of various persons (e.g., players, casino employees, etc.), devices (e.g., user input devices), and/or systems within a predetermined proximity to the component of the gaming establishment fund management system, the component of the gaming establishment patron management system, the component of the gaming establishment hotel system, the component of the retail point-of-sale system and/or the gaming establishment device.

The at least one data preservation component is configured to detect or sense one or more events and/or conditions that, for example, may result in damage to the component of the gaming establishment fund management system, the component of the gaming establishment patron management system, the component of the gaming establishment hotel system, the component of the retail point-of-sale system and/or the gaming establishment device and/or that may result in loss of information associated with the component of the gaming establishment fund management system, the component of the gaming establishment patron management system, the component of the gaming establishment hotel system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected player movements and/or gestures to determine appropriate player input information relating to the detected player movements and/or gestures. For example, in one embodiment, the at least one motion/gesture analysis and interpretation component is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source enables the component of the gaming establishment fund management system, the component of the gaming establishment patron management system, the component of the gaming establishment hotel system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the gaming establishment patron management system, the component of the gaming establishment hotel system, the component of the retail point-of-sale system and/or the gaming establishment device. For example, in one implementation, the at least one geolocation module is configured to receive GPS signal information for use in determining the position or location of the component of the gaming establishment fund management system, the component of the gaming establishment patron management system, the component of the gaming establishment hotel system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the gaming establishment hotel system, the retail point-of-sale system and/or the gaming establishment devices, servers, wireless access points, etc.) and use the signal information to compute position/location information relating to the position or location of the component of the gaming establishment fund management system, the component of the gaming establishment patron management system, the component of the gaming establishment hotel system, the component of the retail point-of-sale system and/or the gaming establishment device.

The at least one user identification module is configured to determine the identity of the current user or current owner of the component of the gaming establishment fund management system, the component of the gaming establishment patron management system, the component of the gaming establishment hotel system, the component of the retail point-of-sale system and/or the gaming establishment device. For example, in one embodiment, the current user is required to perform a login process at the component of the gaming establishment fund management system, the component of the gaming establishment patron management system, the component of the gaming establishment hotel system, the component of the retail point-of-sale system and/or the gaming establishment device in order to access one or more features. Alternatively, the component of the gaming establishment fund management system, the component of the gaming establishment patron management system, the component of the gaming establishment hotel system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the gaming establishment patron management system, the component of the gaming establishment hotel system, the component of the retail point-of-sale system and/or the gaming establishment device that is used to determine the identity of the current user. In at least one embodiment, various security features are incorporated into the component of the gaming establishment fund management system, the component of the gaming establishment patron management system, the component of the gaming establishment hotel system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the gaming establishment patron management system, the component of the gaming establishment hotel system, the component of the retail point-of-sale system and/or the gaming establishment device.

In various embodiments, the component of the gaming establishment fund management system, the component of the gaming establishment patron management system, the component of the gaming establishment hotel system, the component of the retail point-of-sale system and/or the gaming establishment device includes a plurality of communication ports configured to enable the at least one processor of the component of the gaming establishment fund management system, the component of the gaming establishment patron management system, the component of the gaming establishment hotel system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the gaming establishment patron management system, the component of the gaming establishment hotel system, the component of the retail point-of-sale system and/or the gaming establishment device has a support structure, housing, or cabinet that provides support for a plurality of the input devices and the output devices of the component of the gaming establishment fund management system, the component of the gaming establishment patron management system, the component of the gaming establishment hotel system, the component of the retail point-of-sale system and/or the gaming establishment device.

### Differentiating Certain Gaming Devices from General Purpose Computing Devices

It should be appreciated that certain of the gaming devices (e.g., EGMs and/or gaming table components) include certain components and/or are configured to operate in certain manners that differentiate these systems from general purpose computing devices (i.e., certain personal devices such as desktop computers and laptop computers).

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A gaming establishment fund management system comprising:
a processor distinct from and operable with each of a server of a hotel payment system and a server of a gaming establishment credit system; and
a memory device that stores a plurality of instructions that, when executed by the processor, cause the processor to:
responsive to a receipt, from the server of the hotel payment system operating independent of the processor, of data determined by the processor to correspond to an anticipated line of credit use event occurring in association with a first hotel activity associated with the hotel payment system, communicate, to the server of the gaming establishment credit system operating independent of the processor, user data obtained in association with the first hotel activity that, subject to approval of the server of the gaming establishment credit system, enables the gaming establishment credit system in opening a gaming establishment line of credit associated with a user, wherein the user data is obtained independent of any gaming establishment line of credit application and the gaming establishment line of credit associated with the user is opened via a first quantity of inputs received from the user that is less than a second quantity of inputs received from the user in association with an opening of the gaming establishment line of credit occurring independent of the anticipated line of credit use event occurring in association with the first hotel activity, and
responsive to a receipt, from the server of the hotel payment system, of data associated with a second hotel activity occurring in association with the hotel payment system:
automatically determine, based on data received from the server of the gaming establishment credit system, any amount of any outstanding gaming establishment line of credit liability of the user,
responsive to an amount of an outstanding gaming establishment line of credit liability of the user, cause a line of credit settlement event to automatically occur in association with the second hotel activity, and
responsive to the line of credit settlement event automatically occurring in association with the second hotel activity and independent of any inputs received from the user to settle the amount of the outstanding gaming establishment line of credit liability of the user, communicate, to the server of the gaming establishment credit system, data that enables the amount of the outstanding gaming establishment line of credit liability of the user being automatically settled via a payment instrument selected by the user prior to the second hotel activity.

2. The gaming establishment fund management system of claim 1, wherein the second hotel activity comprises the user checking out of a hotel.

3. The gaming establishment fund management system of claim 1, wherein the payment instrument comprises a credit card associated with the user checking into a hotel.

4. The gaming establishment fund management system of claim 1, wherein the first quantity of inputs comprises zero inputs.

5. The gaming establishment fund management system of claim 1, wherein the payment instrument comprises a credit card.

6. The gaming establishment fund management system of claim 1, wherein the memory device stores a plurality of further instructions that, when executed by the processor responsive to the line of credit settlement event occurring in association with the second hotel activity, cause the processor to communicate, to the server of the hotel payment system, data that enables an amount of an outstanding hotel liability of the user also being settled via the payment instrument.

7. The gaming establishment fund management system of claim 1, wherein the second hotel activity is associated with a first merchant category code different from a second merchant category code associated with the outstanding gaming establishment line of credit liability of the user.

8. The gaming establishment fund management system of claim 1, wherein the first hotel activity comprises the user checking into a hotel.

9. A system comprising:
a processor distinct from and operable with each of a server of a hotel payment system and a server of a gaming establishment credit system; and
a memory device that stores a plurality of instructions that, when executed by the processor, cause the processor to:
responsive to a receipt, from the server of the hotel payment system operating independent of the processor, of data determined by the processor to correspond to an anticipated line of credit use event occurring based on a hotel activity occurring in association with the hotel payment system:
independent of any inputs received from a user to apply for a gaming establishment line of credit, automatically communicate user data to the server of the gaming establishment credit system operating independent of the processor, the user data being obtained during the hotel activity, and
responsive to a receipt of data associated with the gaming establishment credit system preapproving, based on the user data obtained during the hotel activity, a gaming establishment line of credit associated with the user, communicate data which results in a display device displaying an amount of credit available to be activated by the user in association with the gaming establishment line of credit.

10. The system of claim 9, wherein the hotel activity comprises the user checking into a hotel.

11. The system of claim 9, wherein the memory device stores a plurality of further instructions that, when executed by the processor responsive to the hotel activity, cause the processor to communicate, to a server of a gaming establishment patron management system, the user data that results in a creation of a gaming establishment patron management system account associated with the user.

12. The system of claim 9, wherein the memory device stores a plurality of further instructions that, when executed by the processor responsive to the hotel activity, cause the processor to communicate, to a server of a gaming establishment fund management system, the user data that results in a creation of a gaming establishment cashless wagering account associated with the user.

13. A method of operating a gaming establishment fund management system, the method comprising:
responsive to a receipt, from a server of a hotel payment system operating independent of a processor of the gaming establishment fund management system, of data determined by the processor to correspond to an anticipated line of credit use event occurring in association with a first hotel activity associated with the hotel payment system, communicating, to a server of a gaming establishment credit system operating independent of the processor gaming establishment fund management system, user data obtained in association with the first hotel activity that, subject to approval of the server of the gaming establishment credit system, enables the gaming establishment credit system in opening a gaming establishment line of credit associated with a user, wherein the user data is obtained independent of any gaming establishment line of credit application and the gaming establishment line of credit associated with the user is opened via a first quantity of inputs received from the user that is less than a second quantity of inputs received from the user in association with an opening of the gaming establishment line of credit occurring independent of the anticipated line of credit use event occurring in association with the first hotel activity, and
responsive to a receipt, from the server of the hotel payment system, of data associated with a second hotel activity occurring in association with the hotel payment system:
automatically determining, by the processor of the gaming establishment fund management system and based on data received from the server of the gaming establishment credit system, any amount of any outstanding gaming establishment line of credit liability of the user,
responsive to an amount of an outstanding gaming establishment line of credit liability of the user, causing a line of credit settlement event to automatically occur in association with the second hotel activity, and
responsive to the line of credit settlement event automatically occurring in association with the second hotel activity and independent of any inputs received from the user to settle the amount of the outstanding gaming establishment line of credit liability of the user, communicating, to the server of the gaming establishment credit system, data that enables the amount of the outstanding gaming establishment line of credit liability of the user being automatically settled via a payment instrument selected by the user prior to the second hotel activity.

14. The method of claim 13, wherein the second hotel activity comprises the user checking out of a hotel.

15. The method of claim 13, wherein the payment instrument comprises a credit card associated with the user checking into a hotel.

16. The method of claim 13, wherein the first quantity of inputs comprises zero inputs.

17. The method of claim 13, wherein the payment instrument comprises a credit card.

18. The method of claim 13, further comprising, responsive to the line of credit settlement event occurring in association with the second hotel activity, communicating, to the server of the hotel payment system, data that enables an amount of an outstanding hotel liability of the user also being settled via the payment instrument.

19. The method of claim 13, wherein the second hotel activity is associated with a first merchant category code different from a second merchant category code associated with the outstanding gaming establishment line of credit liability of the user.

20. The method of claim 13, wherein the first hotel activity comprises the user checking into a hotel.
